(19) United States
(12) Patent Application Publication
(10) Pub. No.: US 2008/0314764 A1
(43) Pub. Date: Dec. 25, 2008

(54) Method for the Electrochemical Decoloration of Indigo-Containing Aqueous Dispersions

(75) Inventors: Wolfgang Schrott, Ludwigshafen (DE); Franz Suetsch, Roedersheim-Gronau (DE); Thomas Bechtold, Dornbirn (AT); Aurora Turcanu, Dornbirn (AT)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/815,790

(22) PCT Filed: Feb. 7, 2006
(86) PCT No.: PCT/EP06/50717

§ 371 Date: Dec. 11, 2007

(30) Foreign Application Priority Data
Feb. 11, 2005 (DE) 10 2005 006 214.8

(51) Int. Cl. C02F 1/461

(52) U.S. Cl. 205/759

(57) ABSTRACT

The present invention relates to a process for electrochemical decolorization of indigo-containing aqueous dispersions by direct anodic oxidation on diamond-coated silicon anodes.

The present invention relates to a process for electrochemical decolorization of indigo from aqueous dispersions by anodic oxidation.

The textile industry is one of the large consumers of water. On the order of 100-200 l of high quality water are needed per kg of dyed textiles. As well as dissolved salts and auxiliaries, textile wastewaters are observed to possess appreciable coloredness measured at wavelengths of 436 nm, 525 nm and 620 nm. Accordingly, all countries having a significant textile industry impose statutory limits on the maximum coloredness of textile wastewaters on discharge into a municipal water treatment plant or on direct discharge. A wide variety of processes for decolorizing dyed textile wastewaters are described in the literature, including electrochemical processing techniques. Electrochemical processing techniques rely on different principles:

1) Electrochemical precipitation/flocculation of dyes which, however, cause the formation of large amounts of wastewater sludge

2) Reductive processes for scissioning the azo group, a technology limited to dissolved dyes containing azo groups, and also the

3) Oxidative destruction of dissolved dyes, for which there are direct and indirect techniques. At the heart of the indirect techniques of treatment is the presence of an oxidizable dissolved entity typically chloride, which is anodically converted to an oxidizing substance, for example hypochlorite. The oxidizing component thus formed is then in turn able to destroy colored chromophores. However, a hypochlorite-based approach is to be deprecated because a high burden of adsorbable halogenated organic compounds (AOX) is imposed on the wastewater. Similar systems can be based on the anodic formation of peroxodisulfate/persulfate, but the low oxidation rate of the entities formed requires a subsequent oxidizing stage at an elevated temperature and in some cases even the use of a pressure reactor, substantially worsening the energy balance of the treatment stage. In the case of dissolved dye systems, direct oxidation of the chromophores can be effected by oxidation at an anode, although other organic ingredients can be oxidized as well with this technique (Van Hege K., et. al. Electrochem. Comm. 4 (2002) 296-300). Frequently, such wastewaters also contain soluble chlorides, so that a mixed form of reaction is present overall and assignment of the effects is not readily possible. Direct oxidation of dye can therefore only be confirmed in the substantial absence of chloride in the treatment bath.

Indigo dyehouses are in a special position with regard to wastewater. Intensively blue wastewaters emanate from the operation of rinsing the dyed yarn on continuous indigo-dyeing ranges. These wastewaters typically contain 0.1-0.5 g/l of indigo dye in dispersed oxidized, i.e., water-insoluble form, and also 2-10 g/l of sodium sulfate from the use of sodium dithionite as a reducing agent in the dyeing operation. The pH of the wash liquors is between 9 and 10, they also contain organic ingredients in the form of surfactants (wetting and dispersing agents) and also detached concomitants of the fiber. However, these wastewaters, unlike other dyehouse wastewaters, do not contain high levels of chlorides, since, unlike other dyeing operations, there is no need for sodium chloride to be added and also the chloride concentrations introduced by the indigo dye and the material to be dyed are negligible.

It is an object of the present invention to provide an environmentally friendly process for oxidative decolorization of indigo-containing wastewater.

We have found that, surprisingly, the use of diamond-coated anodes makes the direct anodic oxidation of dispersed indigo dye in wastewaters possible, and there are no high AOX values.

The present invention accordingly provides a process for direct anodic oxidation of indigo-containing aqueous dispersions on diamond-coated anodes.

The process of the present invention is useful for oxidative decolorization of indigo concentrations in the range from 0.05 g/l to 100 g/l. Different dye concentrations merely require the cell dimensions and the treatment time to be conformed. The decolorization of 2 liters of an aqueous dispersion containing 0.8 g/l of indigo requires around 6 hours with an anode surface area of 12.5 cm² and a 1 A cell current, a more concentrated dispersion takes correspondingly longer; the treatment of a dispersion containing 6.6 g/l of indigo, for example, requires around 90 hours under the same conditions. A larger anode surface area raises the conversion which is dependent on electrode surface area, in turn shortening the treatment time.

The treatment can take place in divided and undivided electrolytic cells. The anode may be constructed of customary anode materials, and especially diamond-coated silicon electrodes will be found particularly useful as anode material.

The sodium sulfate already formed in the course of the dyeing operation can serve as basic electrolyte, in which case working concentrations between 1 and 20 g/l and preferably 4-10 g/l of sodium sulfate are present. Lower concentrations lead to higher cell voltages and higher electrode surface areas, but do not hinder working according to the present invention.

The current density at the anode should be between 0.001 A/cm² and 10 A/cm² and preferably between 0.05 to 1 A/cm².

The pH of the wastewater is between 2 and 13, preferably between 5 and 12 and most preferably between 5 and 10.

The treatment of the wastewaters can take place at temperatures between 15 and 80° C., preferably between 20 and 60° C. and more preferably at the temperature at which the indigo-colored wastewaters arise in any case, which is typically between 20 and 40° C.

The working conditions of the present invention's anodic oxidation of indigo are very useful for the treatment of wastewaters from the dyeing of warp yarns with indigo.

The process of the present invention makes it possible to decolorize indigo-containing wastewater even in the virtually complete absence of chloride ions, which would otherwise result in the well-known prior art side-reaction of hypochlorite formation and hence in the formation of undesirably high AOX concentrations in the treatment bath.

These temperatures are not high enough to elicit the oxidative effect of the by-produced persulfate.

Monitoring of the decolorization is possible by photometry of the wastewater or by analysis of the indigo dye present.

The examples which follow illustrate the functioning of the process of the present invention.

### EXAMPLE 1

The electrochemical treatment takes place in a divided electrolytic cell. A cation exchange membrane (12.5 cm²) serves as separator. The cathode used is a stainless steel sieve electrode having a surface area of 12.5 cm², while the anode used is a diamond-coated doped silicon electrode of 12.5 cm².

The anolyte volume is 2 l, circulation through the cell is provided by a centrifugal pump, at an electrolyte flux of 8 l/min, corresponding to a flow velocity of 43 cm/s parallel to the anode surface.

The catholyte used is a solution of 10 g/l of Na₂SO₄.

The anolyte used is a solution of 10.4 g/l of Na₂SO₄, 5 g/l of NaHCO₃ and 0.2 g/l of oxidized Indigo Solution 40% DyStar. The initial pH of the anolyte is 8.5 and is adjusted to between 5.8 and 7 during the run by addition of NaHCO₃.

The electrolysis is carried out galvanostatically at 1 A cell current (80 mA/cm² current density).

The temperature of the solution varies between 26 and 33° C. Table 1 shows relevant parameters of the example.

| | | Indigo concentration | |
|---|---|---|---|
| Run time | Absorbance | (Analysis of reduced form) | Cell voltage |
| (min) | (620 nm) | mg/l (40% solution) | V |
| 0 | 2.349 | 200 | 17 |
| 180 | 1.089 | 62 | 11 |
| 360 | 0.331 | 5 | 11 |

The degradation of the indigo dye can be monitored directly by photometry at 620 nm or by analyzing the reduced form of the indigo dye.

Depending on the analytical method, the decolorization achieved during the run time is between 85.9% and 97.5% of the initial value.

### EXAMPLE 2

The electrochemical treatment takes place in a divided electrolytic cell. A cation exchange membrane (12.5 cm²) serves as separator. The cathode used is a stainless steel sieve electrode having a surface area of 12.5 cm², while the anode used is a diamond-coated doped silicon electrode of 12.5 cm².

The anolyte volume is 2 l, circulation through the cell is provided by a centrifugal pump, at an electrolyte flux of 8 l/min, corresponding to a flow velocity of 43 cm/s parallel to the anode surface.

The catholyte used is a solution of 10 g/l of Na₂SO₄.

The anolyte used is a solution of 10.5 g/l of Na₂SO₄, 3.3 g/l of NaHCO₃ and 0.21 g/l of oxidized Indigo Solution 40% DyStar. The initial pH of the anolyte is 8.6 and is adjusted to between 4 and 7 during the run by addition of NaHCO₃.

The electrolysis is carried out galvanostatically at 400 mA cell current (32 mA/cm² current density).

The temperature of the solution varies between 26 and 32° C. Table 2 shows relevant parameters of the example.

| | | Indigo concentration | |
|---|---|---|---|
| Run time | Absorbance | (Analysis of reduced form) | Cell voltage |
| (min) | (620 nm) | mg/l (40% solution) | V |
| 0 | 1.857 | 210 | 9.0 |
| 240 | 0.998 | 72 | 6.5 |
| 480 | 0.429 | 32 | 6.3 |

The degradation of the indigo dye can be monitored directly by photometry at 620 nm or by analyzing the reduced form of the indigo dye.

Depending on the analytical method, the decolorization achieved during the run time is between 76.9% and 84.7% of the initial value.

### EXAMPLE 3

The electrochemical treatment takes place in a divided electrolytic cell. A cation exchange membrane (12.5 cm²) serves as separator. The cathode used is a stainless steel sieve electrode having a surface area of 12.5 cm², while the anode used is a diamond-coated doped silicon electrode of 12.5 cm².

The anolyte volume is 2 l, circulation through the cell is provided by a centrifugal pump, at an electrolyte flux of 8 l/min, corresponding to a flow velocity of 43 cm/s parallel to the anode surface.

The catholyte used is a solution of 10 g/l of Na₂SO₄.

The anolyte used is a solution of 10.0 g/l of Na₂SO₄, 5.0 g/l of NaHCO₃ and 25.51 g/l of oxidized Indigo Solution 40% DyStar. The initial pH of the anolyte is 11.22 and decreases during the run to 6.6.

The electrolysis is carried out galvanostatically at 1 A cell current (80 mA/cm² current density).

The temperature of the solution varies between 25 and 31° C. Table 3 shows relevant parameters of the example.

| | | Absorbance of reduced | |
|---|---|---|---|
| Run time | Absorbance | form | Cell voltage |
| (min) | (620 nm) | (405 nm) | V |
| 0 | 2.630 | 3.913 | 22.0 |
| 120 | 3.111 | 3.458 | 10.2 |
| 240 | 2.925 | 3.278 | 10.5 |
| 405 | 2.730 | 2.843 | 11.0 |

The degradation of the indigo dye can be monitored directly by photometry at 620 nm (1 ml of solution diluted to 50 ml with water, 10 mm cell length) or by analysis of the reduced form of the indigo dye (2 ml diluted to 20 ml with reducing solution; 1 mm cell length). The absorbance values of the dispersed indigo initially show an increase, which is due to the changed state of subdivision of the dye during the initial phase. The photometric analysis of the reduced form of the indigo confirms the oxidative degradation of the dye.

Despite the very high dye concentration, around 27% of the dye was decolorized within 405 min.

1-6. (canceled)

7. A process for electrochemically decolorizing an indigo-containing aqueous dispersion comprising directly anodically oxidizing said indigo-containing aqueous dispersion on diamond-coated silicon anodes.

8. The process of claim 7, wherein said indigo-containing aqueous dispersion has an indigo content in the range from 0.05 g/L to 100 g/L.

9. The process of claim 7, wherein said indigo-containing aqueous dispersion has a sulfate concentration of between 1 and 20 g/L of sodium sulfate.

10. The process of claim 9, said indigo-containing aqueous dispersion has a sulfate concentration of between 4 and 10 g/L of sodium sulfate.

11. The process of claim 7, wherein said process is performed in an undivided electrolytic cell.

12. The process of claim 7, wherein said process is performed at temperatures between 15° C. and 80° C., at an anodic current density between 0.001 A/cm² and 10 A/cm², and at a pH of from 2 to 13.

13. The process of claim 7, wherein said indigo-containing aqueous dispersion is indigo-containing wastewater and wherein the electrochemically decolorized indigo-containing wastewater has a low AOX content.
